(19) United States
(12) Patent Application Publication
(10) Pub. No.: US 2026/0104137 A1
(43) Pub. Date: Apr. 16, 2026

(54) DUAL-STRUT CHANNEL AND METHOD OF FABRICATING SAME

(71) Applicant: Capital Hardware Supply, LLC, Closter, NJ (US)

(72) Inventor: David YOSKOWITZ, Woodcliff Lake, NJ (US)

(73) Assignee: Capital Hardware Supply, LLC, Closter, NJ (US)

(21) Appl. No.: 19/331,039

(22) Filed: Sep. 17, 2025

Related U.S. Application Data
(60) Provisional application No. 63/707,894, filed on Oct. 16, 2024.

(51) Int. Cl. F16M 13/02; F16L 3/24; H02G 3/04

(52) U.S. Cl. CPC F16M 13/02; F16L 3/243; H02G 3/0437

(57) ABSTRACT

A dual-strut channel includes a web having a first end and an opposing second end, the first end including a first series of spaced-apart, alternating projections and notches to form a first tooth-like edge, and the opposing second end including a second series of spaced-apart, alternating projections and notches to form a second tooth-like edge. A first flange and an opposing second flange each have a plurality of spaced-apart and aligned apertures which respectively receive the first and second series of spaced-apart, alternating projections extending from the respective first and opposing second ends of the central plate to form an H-shaped dual-strut channel. Exposed upper portions of the first and second series of spaced-apart, alternating projections of the first tooth-like edge are pressed until the first and second series of spaced-apart, alternating projections are flattened and press-fitted within the corresponding ones of the first plurality of spaced-apart and aligned apertures.

### CROSS-REFERENCE TO RELATED APPLICATION

This application claims the benefit of U.S. provisional application No. 63/707,894, filed Oct.. 16, 2024, the content of which is incorporated herein by reference in its entirety.

### FIELD OF THE INVENTION

The present invention is directed to an improved structural support framing assembly and, in particular, a strut channel for use in commercial, residential, and industrial building edifices.

### BACKGROUND OF THE INVENTION

Commercially available strut channel products are used to form elongated support hangers for suspension of ductwork, wire harnesses and the like in commercial, industrial and, less frequently, residential building structures. For example, the strut channel can be used in conjunction with threaded rod and other miscellaneous hardware to hang duct work or wire harnesses from a ceiling or beam of a building.

The prior art strut channels are fabricated from steel or aluminum metals having a C-shaped cross-section, generally in 10 or 20 foot lengths with thicknesses of 12 or 14 gauge. The lengths can be joined or cut to customized sizes depending on the location of application. The lengths can be provided with equidistant openings for receiving the threaded rod and/or other hardware.

In instances where the weight of the structures, e.g., ductwork or wire harnesses exceed a weight capacity of a single strut channel, two strut channels can be arranged back-to-back and welded together at predetermined locations (e.g., every two or three inches) along the length to increase the overall support capacity. Accordingly, the two back-to-back and welded strut channel pieces form a single unit which is available for commercial sale and use.

It has been observed that the double-thickness created when the two strut channels are welded together can be excessive, i.e., having additional steel or aluminum material that is not necessary to provide sufficient structural integrity and support for many commercial usages. Thus, the inclusion of additional steel/aluminum is costly in terms that it is not necessary to carry the required loads. As well, the fabrication of the back-to-back channel strut is expensive to fabricate in terms of time and labor to perform the positioning and welding of the two channels.

Accordingly, it is desirable to provide a strut channel device and method which is not labor intensive, and which can be fabricated without undergoing a welding process. It is also desirable to provide a dual-strut channel that provides adequate support for a desired application without excessive amounts of the materials used to form the dual-strut channel.

### SUMMARY

The subject matter of the present application has been developed in response to the present state of the art, and in particular, in response to the problems of and needs of strut channels which are incapable of supporting various loads without welding or otherwise fastening two strut channels back-to-back to provide sufficient support.

According to one embodiment, a dual-strut channel kit which includes: a central plate having a first end and an opposing second end, the first end including a first series of spaced-apart, alternating projections and notches to form a first tooth-like edge, and the opposing second end including a second series of spaced-apart, alternating projections and notches to form a second tooth-like edge; a first flange having a first plurality of spaced-apart and aligned apertures configured to receive the first series of spaced-apart, alternating projections extending from the first end of the central plate; and a second flange having a second plurality of spaced-apart and aligned apertures configured to receive the second series of spaced-apart, alternating projections extending from the opposing second end of the central plate.

In an aspect, each projection is one of rectangular, triangular, trapezoidal, circular, or elliptical in shape.

In another aspect of the dual-strut channel kit, a first projection of the first series of spaced-apart, alternating projections is angled laterally in a first direction and an adjacent second projection of the first series of spaced-apart, alternating projections is angled laterally in a second direction which is opposite the first direction. In another aspect, a first projection of the second series of spaced-apart, alternating projections is angled laterally in a first direction and an adjacent second projection of the second series of spaced-apart, alternating projections is angled laterally in a second direction which is opposite the first direction.

In another embodiment, a dual-strut channel comprises: a central plate having a first end and an opposing second end, the first end including a first series of spaced-apart, alternating projections and notches to form a first tooth-like edge, and the opposing second end including a second series of spaced-apart, alternating projections and notches to form a second tooth-like edge; a first flange having a first plurality of spaced-apart and aligned apertures configured to receive the first series of spaced-apart, alternating projections extending from the first end of the central plate; and a second flange having a second plurality of spaced-apart and aligned apertures configured to receive the second series of spaced-apart, alternating projections extending from the opposing second end of the central plate; wherein the first series of spaced-apart, alternating projections on the first tooth-like edge of the central plate are inserted into corresponding ones of the first plurality of spaced-apart and aligned apertures and press-fitted therein.

In one aspect of the dual-strut channel, the second series of spaced-apart, alternating projections on the second tooth-like edge of the central plate are inserted into corresponding ones of the second plurality of spaced-apart and aligned apertures and press-fitted therein.

In another aspect, each projection is one of rectangular, triangular, trapezoidal, circular, or elliptical in shape.

In yet another aspect, the central plate, the first flange and the second flange each have a length which extends in a range of six to twenty feet. In a further aspect, the central plate, the first flange and the second flange are fabricated from steel. In still another aspect, the central plate, the first flange and the second flange are fabricated from aluminum.

In a further embodiment, a method of fabricating a dual-strut channel, comprises: providing a central plate having a first end and an opposing second end, the first end including a first series of spaced-apart, alternating projections and notches to form a first tooth-like edge, and the opposing second end including a second series of spaced-apart, alternating projections and notches to form a second tooth-like edge; providing a first flange having a first plurality of spaced-apart and aligned apertures configured to receive the first series of spaced-apart, alternating projections extending from the first end of the central plate; inserting the first series of spaced-apart, alternating projections of the first tooth-like edge of the central plate into corresponding ones of the first plurality of spaced-apart and aligned apertures; and pressing upper portions of the first series of spaced-apart, alternating projections of the first tooth-like edge until the first series of spaced-apart, alternating projections are flattened and press-fitted within the corresponding ones of the first plurality of spaced-apart and aligned apertures.

In one aspect, the method of fabricating a dual-strut channel of claim 17, further comprises: providing a second flange having a second plurality of spaced-apart and aligned apertures configured to receive the second series of spaced-apart, alternating projections extending from the opposing second end of the central plate; inserting the second series of spaced-apart, alternating projections of the second tooth-like edge of the central plate into corresponding ones of the second plurality of spaced-apart and aligned apertures; and pressing upper portions of the second series of spaced-apart, alternating projections of the second tooth-like edge until the second series of spaced-apart, alternating projections are flattened and press-fitted within the corresponding ones of the second plurality of spaced-apart and aligned apertures.

In one aspect of the method of fabricating a dual-strut channel, the method further comprises cutting the dual-strut channel to a predetermined length. In a further aspect, of fabricating a dual-strut channel, the method comprises applying a protective coating over the dual-strut channel.

In still another embodiment, a method of fabricating a dual-strut channel, comprises: providing a central plate having a first end and an opposing second end, the first end including a first series of spaced-apart, alternating projections and notches to form a first tooth-like edge, and the opposing second end including a second series of spaced-apart, alternating projections and notches to form a second tooth-like edge; a first flange having a first plurality of spaced-apart and aligned apertures configured to receive the first series of spaced-apart, alternating projections extending from the first end of the central plate; inserting the first series of spaced-apart, alternating projections of the first tooth-like edge of the central plate into corresponding ones of the first plurality of spaced-apart and aligned apertures; and pressing upper portions of the first series of spaced-apart, alternating projections of the first tooth-like edge until the first series of spaced-apart, alternating projections are bent laterally and positioned against an adjacent upper surface portion of the first flange.

In one aspect, the method of fabricating a dual-strut channel further comprises: providing a second flange having a second plurality of spaced-apart and aligned apertures configured to receive the second series of spaced-apart, alternating projections extending from the opposing second end of the central plate; inserting the second series of spaced-apart, alternating projections of the second tooth-like edge of the central plate into corresponding ones of the second plurality of spaced-apart and aligned apertures; and pressing upper portions of the second series of spaced-apart, alternating projections of the second tooth-like edge until the second series of spaced-apart, alternating projections are bent laterally and positioned against an adjacent upper surface portion of the second flange.

In another aspect, the method of fabricating a dual-strut channel incudes cutting the dual-strut channel to a predetermined length. In still another aspect, the method comprises applying a protective coating over the dual-strut channel.

In another embodiment, a dual-strut channel comprises: a central plate having a first end and an opposing second end, the first end including a first series of spaced-apart, alternating projections and notches to form a first tooth-like edge, and the opposing second end including a second series of spaced-apart, alternating projections and notches to form a second tooth-like edge; a first flange having a first plurality of spaced-apart and aligned apertures configured to receive the first series of spaced-apart, alternating projections extending from the first end of the central plate; and a second flange having a second plurality of spaced-apart and aligned apertures configured to receive the second series of spaced-apart, alternating projections extending from the opposing second end of the central plate; wherein the first series of spaced-apart, alternating projections on the first tooth-like edge of the central plate are inserted into corresponding ones of the first plurality of spaced-apart and aligned apertures and bent to overlay a portion of an exterior surface of the first flange.

In one aspect of the dual-strut channel, the second series of spaced-apart, alternating projections on the second tooth-like edge of the central plate are inserted into corresponding ones of the second plurality of spaced-apart and aligned apertures and bent to overlay a portion of an exterior surface of the second flange.

In another aspect, each projection is one of rectangular, triangular, trapezoidal, circular, or elliptical in shape.

In a further aspect of the dual-strut channel, the central plate, the first flange and the second flange each have a length which extends in a range of six to twenty feet. In yet another aspect, the central plate, the first flange and the second flange are fabricated from steel. In still another aspect, the central plate, the first flange and the second flange are fabricated from aluminum.

In one aspect of the dual-strut channel, a first projection of the first series of spaced-apart, alternating projections is angled laterally in a first direction and an adjacent second projection of the first series of spaced-apart, alternating projections is angled laterally in a second direction which is opposite the first direction. In another aspect of the dual-strut channel, a first projection of the second series of spaced-apart, alternating projections is angled laterally in a first direction and an adjacent second projection of the second series of spaced-apart, alternating projections is angled laterally in a second direction which is opposite the first direction.

The features and advantages of the subject matter of the present disclosure will become more fully apparent from the following description and appended claims as set forth hereinafter.

### BRIEF DESCRIPTION OF THE DRAWINGS

FIG. 1 is a perspective view of a prior art back-to-back strut channel;

FIGS. 2A-2C illustrate components of a first embodiment and a second embodiment of a dual-strut channel of the present invention, in which FIG. 2A illustrates a central plate, FIG. 2B illustrates a top flange and a bottom flange arrange horizontally over and beneath the central plate, and FIG. 2C is a top view of the top flange (the bottom flange being a mirror image thereof) of the first embodiment of a dual-strut channel of the present invention;

FIGS. 3A through 3D illustratively depicts various shaped projections, including rectangular, isosceles trapezoidal, circular, and elliptical shaped projections, respectfully, which are suitable for use and insertion into one of a plurality of conforming-shaped slots formed in the top flange and/or the bottom flange of FIG. 2C;

FIG. 4 is a top, right-side perspective view of the top flange mounted on the central plate of FIG. 2A;

FIG. 5 is a top, side perspective view of a portion of a central plate suitable for use with a second embodiment of the dual-strut channel of the present invention;

FIG. 6 is a front elevation view of the dual-strut channel of FIG. 5 having laterally-angled projections; and

FIG. 7 is a top pan view of the second embodiment of the dual-strut channel depicting the central plate of FIG. 5 attached to a top flange or bottom flange in accordance with the present invention;

FIG. 8 is top, right side perspective view of the first embodiment of a dual-strut channel in accordance with FIGS. 2A-2C and 4 of the present invention;

FIG. 9 is top, right side perspective view of the second embodiment of a dual-strut channel in accordance with FIGS. 5-7 of the present invention.

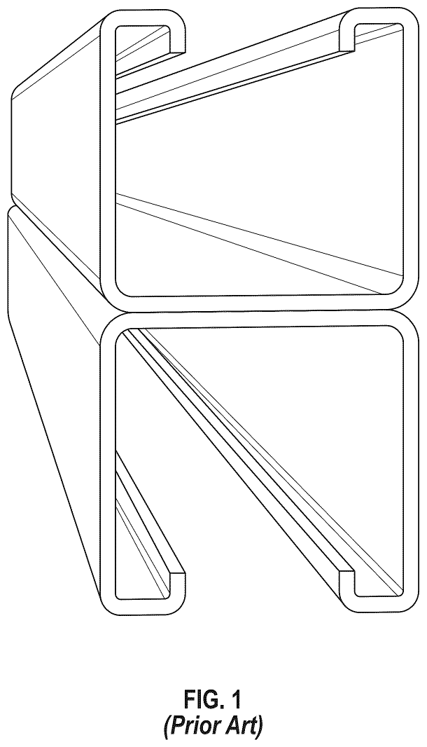

To facilitate understanding of the invention, identical reference numerals have been used, when appropriate, to designate the same or similar elements that are common to the figures.

### DETAILED DESCRIPTION OF THE INVENTION

For purposes of illustration and clarity, the present invention is discussed in the context of a dual-strut channel apparatus, a kit, and a method of fabricating a dual-strut channel apparatus.

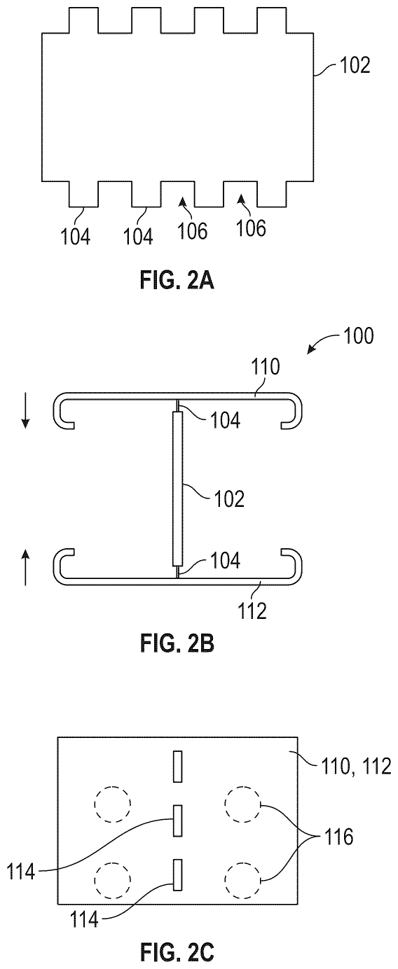

Referring now to FIGS. 2A-2C, 3 and 4, a first embodiment of a dual-strut channel apparatus 100 (hereinafter “strut channel”) is illustratively shown. The strut channel 100 includes a web or central plate 102 which is positioned and attached between a first flange 110 and a second flange 112. The first and second flanges 110, 112 are planar or substantially planar, although such shape is not considered limiting. In FIG. 2B, the orientation of the central plate 102 is illustratively shown vertically with respect to the first and second flanges 110, 112. A person of ordinary skill in the art will appreciate that the orientation of the central plate and flanges to form the finished product are not considered limiting, as the strut channel can be assembled at any orientation with respect to the cross-sectional view of FIG. 2B. The central plate 102 is illustratively positioned centrally between lateral edges of the flanges 110, 112, although such positioning is not considered limiting.

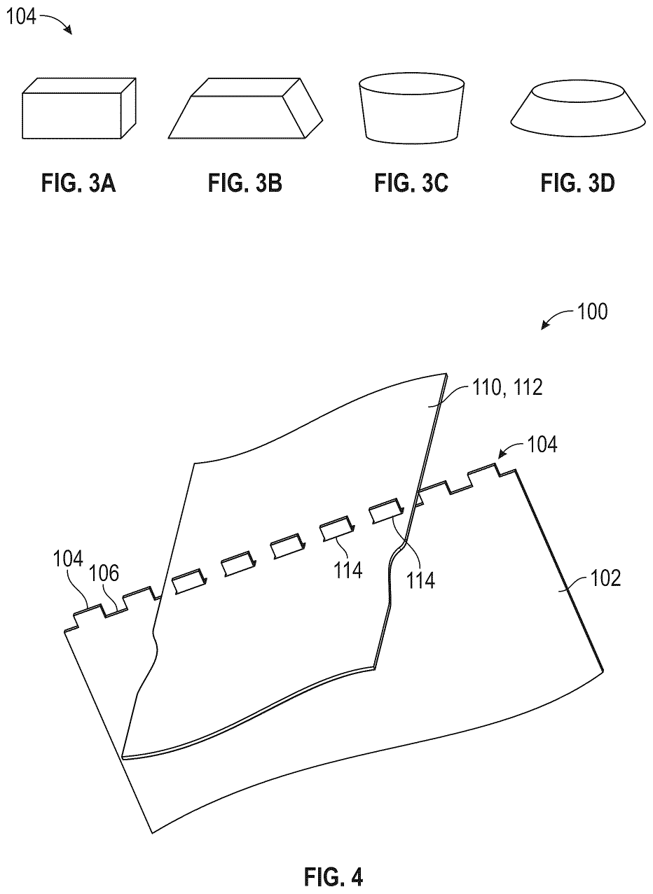

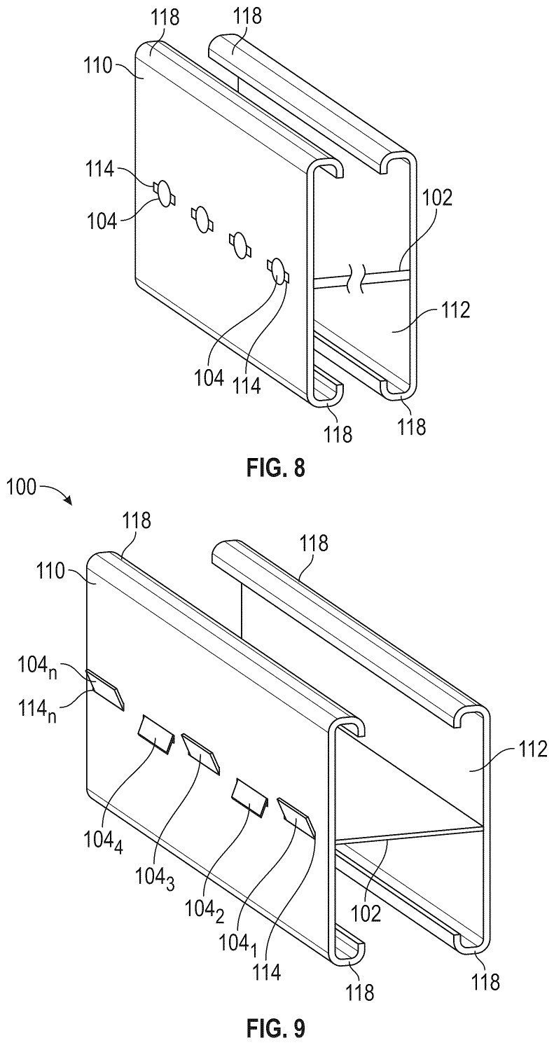

Referring to FIG. 2A, the web or central plate 102 (hereinafter “central plate”) is rectangular in shape having a first edge with equidistant, spaced-apart projections 104 which form notches 106 therebetween and an opposing, parallel second edge also with equidistant, spaced-apart projections 104 which form notches 106 therebetween. The projections 104 and alternating notches 106 therebetween form a tooth-like edge. In FIG. 2B, the arrangement of the first and second plates 110 and 112 are shown with respect to the central plate 102. The first and second edges are arranged normal to the lateral edges of the rectangular flanges 110, 112. FIG. 2C illustrates a plurality of equidistant, spaced-apart slots 114 formed in the first and second flanges 110, 112. Each of the slots 114 is sized and dimensioned to receive a corresponding projection 104, as illustratively shown in FIGS. 3A-3D and 4. The first and second flanges 110, 112 can also include a plurality of apertures 116, as illustratively shown in phantom in FIG. 2C. The plurality of apertures 116 are sized and dimensioned for receiving threaded rods and/or other hardware (not shown). A person of ordinary skill in the art will appreciate that the height of the central plate 102 can vary depending on the implementation. Referring to FIGS. 8-9, each lateral side of the first and second flanges 110, 112 terminate at inwardly orientated flanges 118. The inwardly orientated flanges are preferably J-shaped flanges, which are suitable for interfacing with support hardware to support the dual-strut channel from above, e.g., via threaded rod and fasteners for mounting to a ceiling support beam, or to support a load (e.g., ductwork) hung from/below the dual-strut channel 100. A person of ordinary skill in the art will appreciate that the shape of the inwardly orientated flanges 118 is not limiting. Moreover, a person of ordinary skill in the art will appreciate that the flanges 118 can alternatively extend in an outwardly direction.

In an embodiment, the central plate can be wave-shaped along the length to provide greater strength and stability between the opposing flanges 110, 112. Preferably, the projections 104 are positioned so as to be aligned linearly along the first and second edges thereof. Alternatively, each of the projections 104 is offset from an adjacent projection 104. In this alternative embodiment, the planar flanges 110, 112 include slots 114 in a corresponding offset arrangement on the flanges to receive the projections 104.

Referring to FIGS. 3A-3D, the projections 104 are shown having various shapes. For example, the projections can illustratively be rectangular shaped as shown in FIG. 3A, isosceles trapezoidal shaped as shown in FIG. 3B, circular as shown in FIG. 3C, or elliptical as shown in FIG. 3D. A person of ordinary skill in the art will appreciate that the slots 114 in the first and second flanges 110, 112 have corresponding dimensions and are sized to receive the shaped projections 104. The shapes of the projections 104 (and corresponding slots 114) as shown and described herein are not considered limiting, as other shaped projections, e.g., triangular, cone, bulbous, polygonal and the like can be utilized.

Referring to FIG. 4, the projections 104 have a height that is greater than the thickness of the first and second flanges 110, 112. In other words, when assembled, the projections 104 extend a predetermined height above the exterior or outer surface of the first and second flanges 110, 112.

During initial assembly of the strut channel 100, the projections 104 on the first edge of the central plate 102 are aligned with and inserted through the slots 114 of first flange 110 until the adjacent underside surfaces of the first flange 110 contacts the upper surfaces of the notches 106. Likewise, the projections 104 on the second edge of the central plate 102 are aligned with and inserted through the slots 114 of second flange 112 until the adjacent underside surfaces of the second flange 112 contacts the upper surfaces of the notches 106. As noted above, the projections 104 are exposed, i.e., extend outwardly a predetermined distance (e.g., 1/32″, 1/16″, ⅛″, 3/16″ and the like) from the corresponding slots 114 of the first and second flanges 110, 112.

After initial assembly, the assembled strut channel undergoes a pressing operation to deform and flatten the projections 104 within the respective slots 114 so as to secure the first and second flanges 110, 112 to the opposing first and second edges of the central plate 102. Preferably, opposing forces are applied simultaneously or contemporaneously to the projections on the opposite first and second edges and the first and second flanges 110, 112 over a predetermined length (e.g., 10-foot or 20-foot lengths) of the strut channel 100. The pressing operation can be performed by a mechanical press, rollers, and the like.

The pressing operation causes the projections 104 to deform and flatten so that they expand within, and in one embodiment, over the slot to secure the first and second flanges 110, 112 to the opposing ends of the central plate 102, as illustratively shown in FIG. 8. Optionally, a grinding step can be provided over the length of the strut channel 100 to eliminate any portions of the projections 104 that extend above the outer/exterior surface of the first and second flanges 110, 112. A person of ordinary skill in the art will appreciate the height of the projections 104 on the central plate 102 with respect to the outer surface of the flanges 110, 112 can be determined and subsequently adjusted based on the desired results of the press-fitting step, so as to minimize the height of the projection and thus the grinding operation, as deemed necessary. Accordingly, the configuration of the central plate 102 with the first and second flanges 110, 112 allows for quick assembly, and the press-fit operation avoids any labor-intensive welding operation and significantly reduces the metal materials used to form the dual-strut channels 100.

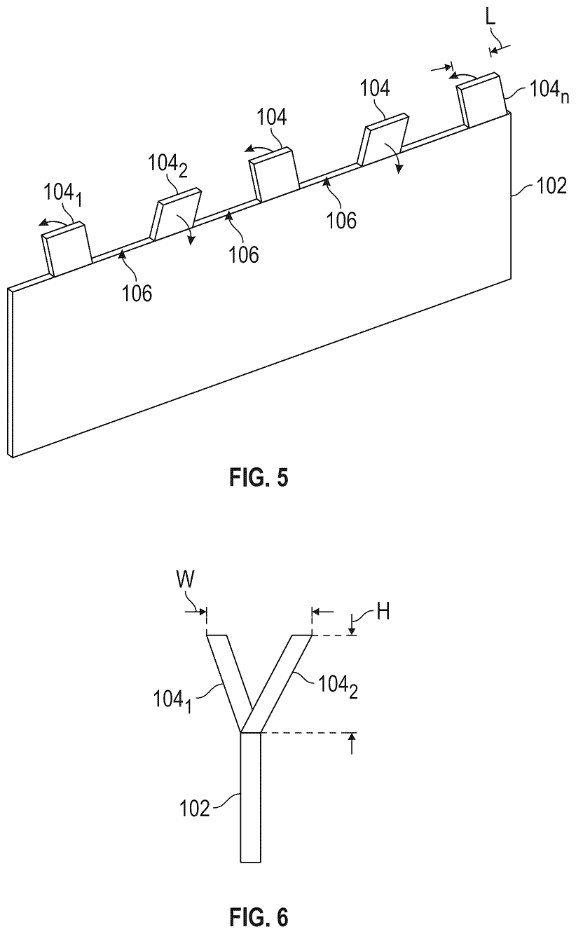

Referring now to FIGS. 5-7 and 9, a second embodiment of the dual-strut channel is illustratively shown. In this second embodiment, the projections 104 of the central plate 102 are not press-fitted within the corresponding slots 114 of the first and second flanges 110, 112. Instead, the projections 104 are angled laterally and bent downward during a pressing action to lock the flanges between the upper surface of the notches 106 and the bent underside of the projections 104. The projections 104 can be any shape, as discussed above with respect to the illustrative (non-limiting) FIGS. 3A-3D.

In particular and referring to FIG. 5, the central plate 102 is illustratively shown and the projections 104, i.e., projections 104₁ through 104ₙ (where “n” is an integer greater than 1) are angled laterally, e.g., left or right with respect to the drawing. Referring to FIG. 6, a first projection 104₁ is shown angled to the left and an adjacent second projection 104₂ is angled to the right. This pattern is repeated along the length of the central plate 102. The notches 106 are formed between each adjacent projection 104, as described above.

The outermost edges of the laterally-angled projections define a width “W” there between, as shown in FIG. 6. The width W between the outermost edges of the laterally-angled projections 104 defines the width of the corresponding slots 114 formed in the first and second flanges 110, 112. Moreover, the laterally-angled projections 104 have a predetermined height “H” which exceeds the width of the corresponding slots 114 formed in the first and second flanges 110, 112, as also shown in FIG. 6. For example, the projections 104 of the central plate 102 can illustratively have a width W of ¼″, a height H of ⅜″ and the slots 114 of the first and second flanges 110, 112 can have a width of 5/16″, although such dimensions are not considered limiting. As such, the slots 114 have sufficient clearance to permit the laterally-angled projections 104 of the central plate 102 to be inserted through the corresponding slots 114 of the first and second flanges 110, 112 during initial assembly. The thickness of the projections 104 in any embodiment discussed herein can be 12 or 14 gauge and the lengths “L” of each projection 104 can illustratively be in the range of ⅛′ to ¼″, although such dimensions are not considered limiting.

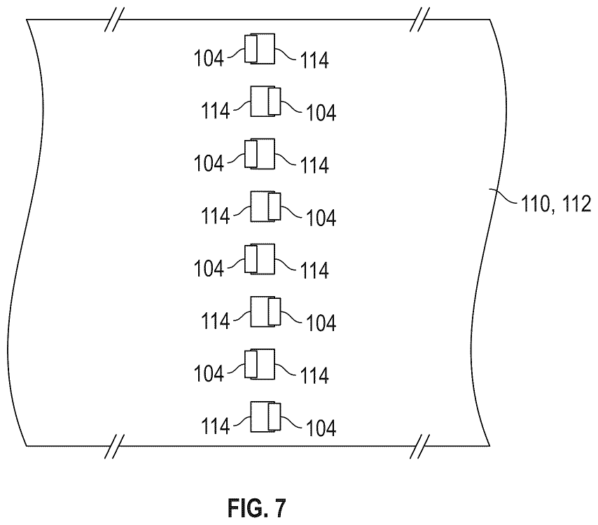

Referring to FIG. 7, after a pressing operation of the predetermined length of the initially assembled dual-strut channel, for example, by a mechanical press or rollers, a final product is formed in which the laterally-angled projections are bent downward and preferably flattened to lock the central plate to the opposing flanges 110, 112. In particular, each flange 110, 112 is positioned and retained in place with respect to the central plate 102 by the underside surface of the flanges in contact or abutting against the upper surface of each of the notches 106, and the underside surface of each bent, laterally-angled projection is in contact or abutting against a top or exterior surface of the corresponding flange 110, 112.

As with the first embodiment, the configuration of the central plate 102 with the first and second flanges 110, 112 of the second embodiment of the strut channel 100 allows for quick assembly, and the press-fit operation avoids any labor-intensive welding operation and significantly reduces the metal materials used to form the dual-strut channels 100.

In either embodiment, a coating process can be provided to protect the exterior surface of the strut channel 100. Preferably, a coating process is performed prior to the first and second flanges 110, 112 and the central plate 102 being assembled, although the timing of a coating process is not considered limiting.

Although the strut channel 100 is shown and described as a finished product, a person of ordinary skill in the art will appreciate that the central plate 102 with its predetermined sized projections 104, and the first and second flanges 110, 112 with their predetermined sized slots 114 to receive the projections 104 can be formed in extended lengths and transported as a kit for final assembly at a remote location.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

### LISTING OF REFERENCE DESIGNATIONS

100 Dual-strut Channel
102 Central plate
104 Series of spaced-apart and aligned projections
106 Notches
110 First flange
112 Second flange
114 Series of spaced-apart and aligned apertures
116 Apertures
118 inwardly orientated flanges
L Length of a projection
W Outermost width as between two laterally-angled projections
H Height of a projection

What is claimed is:

1. A strut channel kit comprising:
a central plate having a first end and an opposing second end, the first end including a first series of spaced-apart, alternating projections and notches to form a first tooth-like edge, and the opposing second end including a second series of spaced-apart, alternating projections and notches to form a second tooth-like edge;
a first flange having a first plurality of spaced-apart and aligned apertures configured to receive the first series of spaced-apart, alternating projections extending from the first end of the central plate; and
a second flange having a second plurality of spaced-apart and aligned apertures configured to receive the second series of spaced-apart, alternating projections extending from the opposing second end of the central plate.

2. The strut channel kit of claim 1, wherein in an assembled state the first series of spaced-apart, alternating projections on the first tooth-like edge of the central plate are inserted into corresponding ones of the first plurality of spaced-apart and aligned apertures and bent to overlay a portion of an exterior surface of the first flange; and
the second series of spaced-apart, alternating projections on the second tooth-like edge of the central plate are inserted into corresponding ones of the second plurality of spaced-apart and aligned apertures and bent to overlay a portion of an exterior surface of the second flange.

3. The strut channel kit of claim 1, wherein each projection is one of rectangular, trapezoidal, triangular, circular, or elliptical in shape.

4. The strut channel kit of claim 1, wherein a first projection of the first series of spaced-apart, alternating projections is angled laterally in a first direction and an adjacent second projection of the first series of spaced-apart, alternating projections is angled laterally in a second direction which is opposite the first direction.

5. The strut channel kit of claim 1, wherein a first projection of the second series of spaced-apart, alternating projections is angled laterally in a first direction and an adjacent second projection of the second series of spaced-apart, alternating projections is angled laterally in a second direction which is opposite the first direction.

6. The strut channel kit of claim 1, wherein in an assembled state the first series of spaced-apart, alternating projections on the first tooth-like edge of the central plate are inserted and press fit into corresponding ones of the first plurality of spaced-apart and aligned apertures; and
the second series of spaced-apart, alternating projections on the second tooth-like edge of the central plate are inserted and press fit in corresponding ones of the second plurality of spaced-apart and aligned apertures.

7. A dual-strut channel comprising:
a central plate having a first end and an opposing second end, the first end including a first series of spaced-apart, alternating projections and notches to form a first tooth-like edge, and the opposing second end including a second series of spaced-apart, alternating projections and notches to form a second tooth-like edge;
a first flange having a first plurality of spaced-apart and aligned apertures configured to receive the first series of spaced-apart, alternating projections extending from the first end of the central plate;
a second flange having a second plurality of spaced-apart and aligned apertures configured to receive the second series of spaced-apart, alternating projections extending from the opposing second end of the central plate;
wherein the first series of spaced-apart, alternating projections on the first tooth-like edge of the central plate are inserted into corresponding ones of the first plurality of spaced-apart and aligned apertures and press-fitted therein; and
wherein the second series of spaced-apart, alternating projections on the second tooth-like edge of the central plate are inserted into corresponding ones of the second plurality of spaced-apart and aligned apertures and press-fitted therein.

8. The dual-strut channel of claim 7, wherein each projection is one of rectangular, trapezoidal, triangular, circular, or elliptical in shape.

9. The dual-strut channel of claim 7, wherein the central plate, the first flange and the second flange each have a length which extends in a range of six to twenty feet.

10. The dual-strut channel of claim 7, wherein the central plate, the first flange and the second flange are fabricated from metal.

11. A method of fabricating a dual-strut channel, comprising:
providing a central plate having a first end and an opposing second end, the first end including a first series of spaced-apart, alternating projections and notches to form a first tooth-like edge, and the opposing second end including a second series of spaced-apart, alternating projections and notches to form a second tooth-like edge;
providing a first flange having a first plurality of spaced-apart and aligned apertures configured to receive the first series of spaced-apart, alternating projections extending from the first end of the central plate;
inserting the first series of spaced-apart, alternating projections of the first tooth-like edge of the central plate into corresponding ones of the first plurality of spaced-apart and aligned apertures; and
pressing upper portions of the first series of spaced-apart, alternating projections of the first tooth-like edge until the first series of spaced-apart, alternating projections are flattened and press-fitted within the corresponding ones of the first plurality of spaced-apart and aligned apertures.

12. The method of fabricating a dual-strut channel of claim 11, further comprising:
providing a second flange having a second plurality of spaced-apart and aligned apertures configured to receive the second series of spaced-apart, alternating projections extending from the opposing second end of the central plate;
inserting the second series of spaced-apart, alternating projections of the second tooth-like edge of the central plate into corresponding ones of the second plurality of spaced-apart and aligned apertures; and
pressing upper portions of the second series of spaced-apart, alternating projections of the second tooth-like edge until the second series of spaced-apart, alternating projections are flattened and press-fitted within the corresponding ones of the second plurality of spaced-apart and aligned apertures.

13. The method of fabricating a dual-strut channel of claim 11, further comprising cutting the dual-strut channel to a predetermined length.

14. The method of fabricating a dual-strut channel of claim 11, further comprising applying a protective coating over the dual-strut channel.

15. A method of fabricating a dual-strut channel, comprising:
providing a central plate having a first end and an opposing second end, the first end including a first series of spaced-apart, alternating projections and notches to form a first tooth-like edge, and the opposing second end including a second series of spaced-apart, alternating projections and notches to form a second tooth-like edge;
providing a first flange having a first plurality of spaced-apart and aligned apertures configured to receive the first series of spaced-apart, alternating projections extending from the first end of the central plate;
inserting the first series of spaced-apart, alternating projections of the first tooth-like edge of the central plate into corresponding ones of the first plurality of spaced-apart and aligned apertures; and
pressing upper portions of the first series of spaced-apart, alternating projections of the first tooth-like edge until the first series of spaced-apart, alternating projections are bent laterally and positioned against an adjacent upper surface portion of the first flange.

16. The method of fabricating a dual-strut channel of claim 15, further comprising:
providing a second flange having a second plurality of spaced-apart and aligned apertures configured to receive the second series of spaced-apart, alternating projections extending from the opposing second end of the central plate;
inserting the second series of spaced-apart, alternating projections of the second tooth-like edge of the central plate into corresponding ones of the second plurality of spaced-apart and aligned apertures; and
pressing upper portions of the second series of spaced-apart, alternating projections of the second tooth-like edge until the second series of spaced-apart, alternating projections are bent laterally and positioned against an adjacent upper surface portion of the second flange.

17. The method of fabricating a dual-strut channel of claim 15, further comprising cutting the dual-strut channel to a predetermined length.

18. The method of fabricating a dual-strut channel of claim 15, further comprising applying a protective coating over the dual-strut channel.

19. The method of fabricating a dual-strut channel of claim 15, wherein a first projection of the first series of spaced-apart, alternating projections is angled laterally in a first direction and an adjacent second projection of the first series of spaced-apart, alternating projections is angled laterally in a second direction which is opposite the first direction.

20. The method of fabricating a dual-strut channel of claim 15, wherein a first projection of the second series of spaced-apart, alternating projections is angled laterally in a first direction and an adjacent second projection of the second series of spaced-apart, alternating projections is angled laterally in a second direction which is opposite the first direction.
